(19) United States
(12) Patent Application Publication
(10) Pub. No.: US 2002/0118171 A1
(43) Pub. Date: Aug. 29, 2002

(54) Pointing device with an input panel

(76) Inventor: Yu-Chih Cheng, Taipei City (TW)

Correspondence Address: Winston Hsu, NAIPO(North America International Patent Office), P O Box 506, Merrifield, VA, 22116, US

(21) Appl. No.: 09/848,374

(22) Filed: May 4, 2001

(30) Foreign Application Priority Data
Feb. 9, 2001 (TW) 090102966

(51) Int. Cl. G09G 5/08

(52) U.S. Cl. 345/163

(57) ABSTRACT

A pointing device comprises a housing, a displacement signal generator located in the housing for generating displacement signals, and an input panel installed on the housing for inputting image data. The image data inputted to the input panel is transmitted to a computer to perform an identification process.

### BACKGROUND OF THE INVENTION

1. Field of the Invention

The present invention relates to a pointing device, and more particularly, to a pointing device with an image data input panel.

2. Description of the Prior Art

Electronic transactions through networks are becoming a new commercial practice, and the importance of these transactions is growing with each passing day.

Although electronic transactions are becoming more widely used, the security of contemporary electronic transactions is still not foolproof, especially as regards the problem of customer identification. Customers need to validate their identify to a seller on the network, but at the same time, they don't want this information to be compromised. One method to overcome this is to utilize an electronic signature of the customer to form a basis for identification.

Please refer to FIG. 1. FIG. 1 is a diagram of a prior art pointing device 10. The pointing device 10 has a housing 12, a roller 14 installed in the housing 12 for sensing displacements of the pointing device 10 to generate corresponding pointing signals, and at least a button 15 installed on a top surface of the housing. The pointing device 10 is usually electrically connected to a host computer, which indicates the pointing signals on a monitor 18 of the computer host 16.

However, while the pointing device 10 is used to adjust a cursor position on the monitor 18, it must be used in conjunction with a keyboard (not shown) or a handwriting panel (not shown), and so its functionality is limited. These limits require the user to use the handwriting panel to input handwriting when processing electronic transactions and signature identification on the network. The pointing device and the handwriting panel are both needed to perform electronic transactions, and this not only places a burden on computer resources (occupying two I/O ports of the computer), but also requires a large amount of desktop space. The user must operate two devices in turns, and this negates both the convenience offered by electronic transactions, and the willingness of the user to perform these electronic transactions.

### SUMMARY OF THE INVENTION

It is therefore a primary objective of the present invention to provide a pointing device with a handwriting panel to solve the above mentioned problems.

In a preferred embodiment, the present invention provides a pointing device with an input panel. The pointing device comprises a housing, a displacement signal generator installed on the housing for generating displacement signals, and an input panel installed on the housing for inputting image data. The image data inputted by the input panel is transmitted to a computer to perform an identification process.

It is an advantage of the present invention that the pointing device enables the user to directly perform a signature identification process on the pointing device 5 directly when shopping online, thus ensuring that electronic transactions are carried out securely with the consent of both the buyer and the seller. This can help to prevent unauthorized use if a credit card, or a credit card number, is stolen.

These and other objectives and advantages of the present invention will no doubt become obvious to those of ordinary skill in the art after having read the following detailed description of the preferred embodiment that is illustrated in the various figures and drawings.

### BRIEF DESCRIPTION OF THE DRAWINGS

FIG.1 is a diagram of a prior art pointing device.

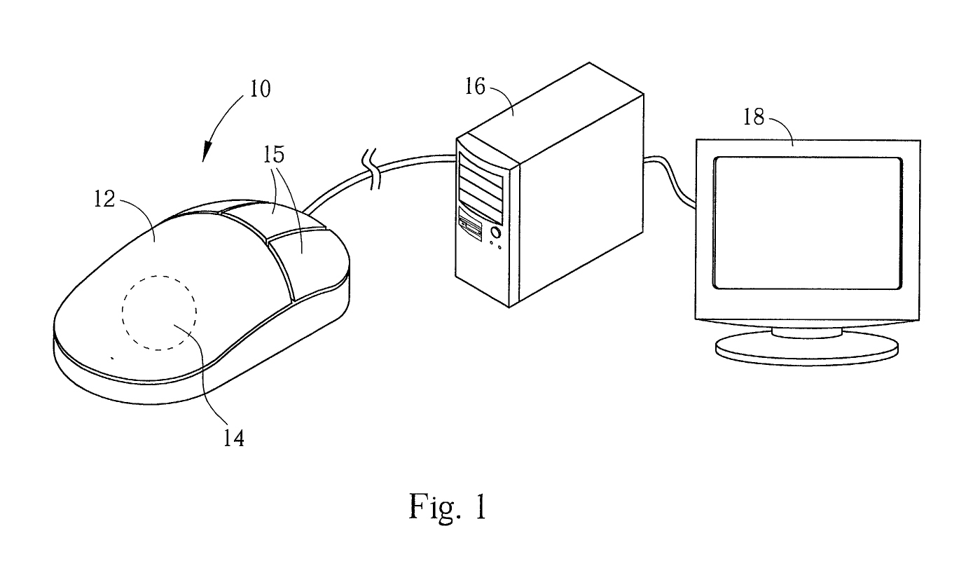

FIG.2 is a diagram of the present invention pointing device.

FIG.3 is a diagram of an alternative pointing device of the present device.

### DETAILED DESCRIPTION OF THE PREFERRED EMBODIMENT

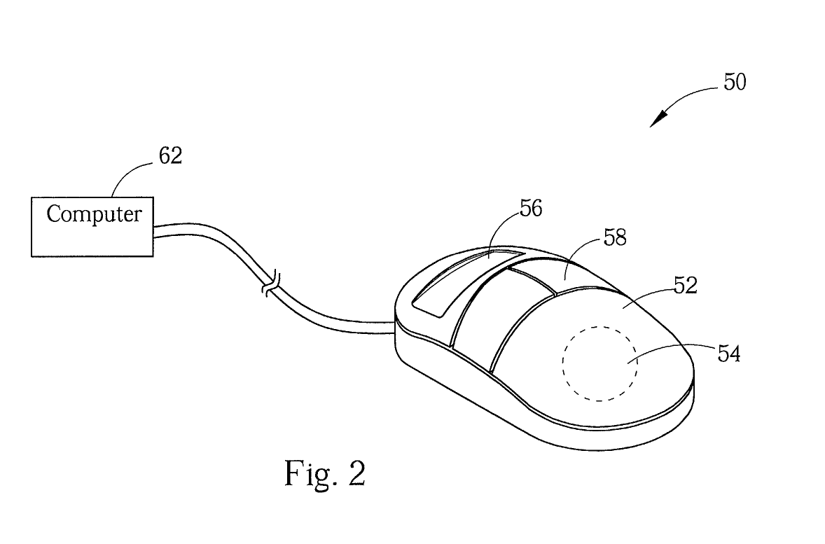

Please refer to FIG. 2. FIG. 2 is a diagram of the present invention pointing device 50. The pointing device 50 has a housing 52, a displacement signal generator 54 installed on the housing 52 for sensing displacements of the pointing device 50 to generate corresponding pointing signals, an input panel 56 installed on the housing 52 for inputting image data, and at least a button 58 also installed on the housing 52 for generating button signals. The pointing device 50 is electrically connected to a computer 62 to provide the pointing signals generated by the pointing device, button signals by the user, and image data. These signals are displayed on a monitor (not shown) of the computer 62 after encoding and decoding, and the computer device 62 comprises at least a software driver to support the pointing device 50.

The housing 52 of the pointing device 50 further comprises a controlling circuit (not shown) electrically connected to the displacement signal generator 54, input panel 56, and the button 58 for controlling the operations of the pointing device 50, and for encoding the pointing signals generated by button signals, handwriting signals through the input panel 56, and the image data. The computer 62 decodes all this information and allows for operation of the pointing device.

The computer 62 can be electrically connected to the Internet. When the user utilizes the pointing device 50 to navigate among electric goods on web sites, the user not only can select choices with the button 58, but can also authenticate the validity of the transaction with the input panel 56.

The displacement signal generator 54 of the preferred embodiment is a roller, and the pointing device 50 is a mouse.

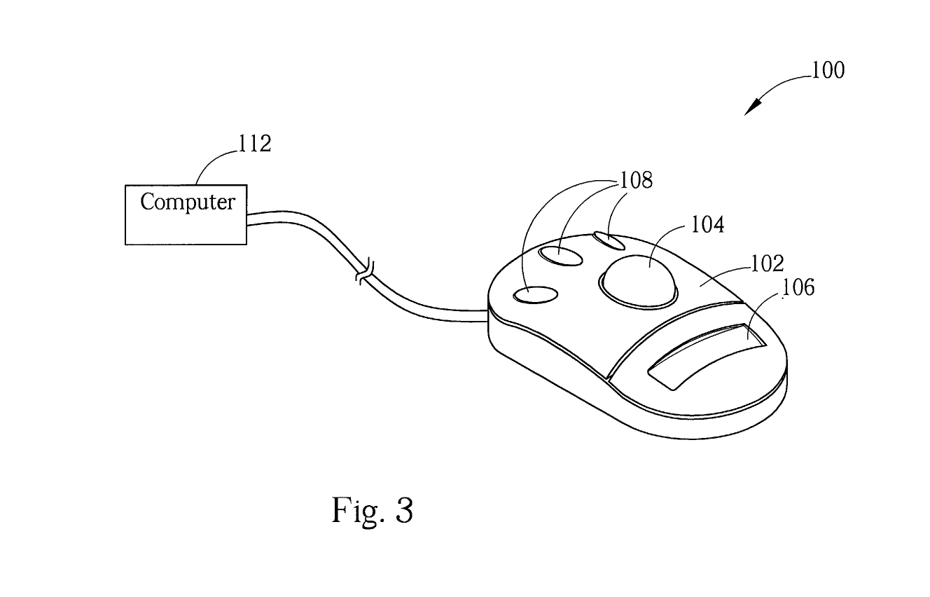

Please refer to FIG. 3. FIG. 3 is a diagram of an alternative pointing device 100 of the present device. The pointing device 100 has a housing 102, a displacement sensor device 104 on the housing 102, an input panel 106 on the housing 102 for handwriting input or inputting image data, and at least a button 108 also on the housing 102 for generating button signals. The pointing device 100 is electrically connected to a computer device 112 to input pointing signals generated by the pointing device 100, handwriting input by the user via the pointing device 100, and image data from the pointing device 100. These signals are displayed onamonitor (not shown) of the computer 112 after an encoding process, and the computer 112 comprises at least a driver to support the pointing device 100. The displacement sensor device of the pointing device 100 is a track ball. The user generates displacement signals by rotating the track ball, generating corresponding pointing signals.

Further installed within the housing 102 of the pointing device 100 is a control circuit (not shown) electrically connected to the displacement signal generator 104, the input panel 106, and the button 108 for controlling operations of the pointing device 100, and for encoding the pointing signals generated by the pointing device 100, and encoding the button signals, the handwriting signals generated via the panel 106, and the image data. After being decoded in the computer device 112, these signals are capable of being processed normally. The computer 112 is capable of electrically connecting to the Internet. When the user utilizes the pointing device 100 to navigate among goods offered on web sites, the user not only can use the button 108 to select a range of goods, but may also input signature and payment information directly using the pointing device 100 to authenticate the validity of the transaction.

The pointing devices 50, 100 are both capable of working with word-processing software. Text can be inputted through the input panels 56, 106 without a keyboard by using the present invention pointing device 50 or 100. Even image data can be inputted directly to expand the application range of the present invention pointing devices 50, 100.

In contrast to the prior art, the present invention pointing device provides an input panel, so a user can use the input panel for signatures, handwriting data, or image data directly. The signature identification of the customer ensures the security of electronic transactions. Inputting handwriting data and image data in this way expands the application range of the pointing device.

Those skilled in the art will readily observe that numerous modifications and alternations of the device may be made while retaining the teachings of the invention. Accordingly, the above disclosure should be construed as limited only by the metes and bounds of the appended claims.

What is claimed is:

1. A pointing device comprising:
a housing;
a displacement signal generator installed in the housing for generating displacement signals; and
an input panel installed on the housing for inputting image data;
wherein the image data inputted to the input panel will be transmitted to a computer to perform an identification process.

2. The pointing device of claim 1 being a mouse.

3. The pointing device of claim 2 wherein the displacement signal generator comprises a roller installed at bottom of the housing for generating displacement signals.

4. The pointing device of claim 1 wherein the displacement signal generator comprises a track ball installed at a top end of the housing for generating displacement signals.

5. The pointing device of claim 1 further comprising a button installed on the housing for generating button signals.
